(19) United States
(12) Patent Application Publication
(10) Pub. No.: US 2023/0219413 A1
(43) Pub. Date: Jul. 13, 2023

(54) VEHICLE CONTROL DEVICE, VEHICLE CONTROL METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Hirofumi MORI, Hadano-shi (JP); Vanquyhung NGUYEN, Sunto-Gun (JP)

(21) Appl. No.: 18/057,791

(22) Filed: Nov. 22, 2022

(30) Foreign Application Priority Data
Jan. 11, 2022 (JP) 2022-002488

(51) Int. Cl. B60K 31/02; B60K 31/00

(52) U.S. Cl. CPC B60K 31/02; B60K 31/0008

(57) ABSTRACT

A vehicle control device includes: a processor, the processor being configured to: acquire position information regarding a preceding vehicle traveling ahead of a host vehicle; and control a reaction force application mechanism based on a vehicle spacing in a vehicle width direction between the host vehicle and the preceding vehicle, the reaction force application mechanism being configured to apply a reaction force to an accelerator pedal.

### CROSS-REFERENCE TO RELATED APPLICATION

This application is based on and claims priority under 35 USC 119 from Japanese Patent Application No. 2022-002488 filed on Jan. 11, 2022, the disclosure of which is incorporated by reference herein.

### BACKGROUND

### Technical Field

The present disclosure relates to a vehicle control device, a vehicle control method, and a non-transitory storage medium storing a program.

### Related Art

Japanese Patent Application Laid-open (JP-A) No. 2003-205760 discloses a vehicle driving operation assistance device that calculates a degree of risk in the surroundings of a host vehicle, and increases a reaction force of an accelerator pedal as the calculated degree of risk increases. In the vehicle driving operation assistance device described in JP-A No. 2003-205760, the configuration is such that the degree of risk is calculated based on the inter-vehicle distance relative to a preceding vehicle that the host vehicle should follow behind, and the relative vehicle speed.

However, in the device described in JP-A No. 2003-205760, there is a possibility that a reaction force will be applied to the accelerator pedal in a situation in which the driver of the host vehicle wishes to accelerate, such as a situation in which the preceding vehicle is turning right or left. For this reason, there is room for improvement in terms of performing driving assistance without hindering driving.

### SUMMARY

The present disclosure provides a vehicle control device, a vehicle control method, and a program that are capable of providing driving assistance without hindering driving.

A vehicle control device of a first aspect includes a processor, the processor being configured to: acquire position information regarding a preceding vehicle traveling ahead of a host vehicle; and control a reaction force application mechanism based on a vehicle spacing in a vehicle width direction between the host vehicle and the preceding vehicle, the reaction force application mechanism being configured to apply a reaction force to an accelerator pedal.

In the vehicle control device of the first aspect, the processor acquires position information regarding a preceding vehicle traveling ahead of a host vehicle. Moreover, the processor controls a reaction force application mechanism, which applies a reaction force to an accelerator pedal, based on a vehicle spacing in a vehicle width direction between the host vehicle and the preceding vehicle. In this way, the reaction force application mechanism is controlled in consideration of the vehicle spacing between the host vehicle and the preceding vehicle in the vehicle width direction. This enables suppression of inadvertent application of a reaction force to the accelerator pedal in a situation in which the driver wishes to accelerate, such as immediately after the preceding vehicle has turned right or left. The term “vehicle spacing in the vehicle width direction” as used herein is not limited to a vehicle spacing distance in a vehicle width direction, and is a concept broadly encompassing a vehicle interval time.

A vehicle control device of a second aspect is the first aspect, in which a state in which the reaction force has been applied to the accelerator pedal in a case in which a vehicle spacing in a front-rear direction between the host vehicle and the preceding vehicle is smaller than a first threshold value is designated an applied state, and the processor controls the reaction force application mechanism so as to reduce the reaction force applied to the accelerator pedal in a case in which the vehicle spacing in the vehicle width direction between the host vehicle and the preceding vehicle is larger than a second threshold value in the applied state.

In the vehicle control device of the second aspect, in a case in which the vehicle spacing between the host vehicle and the preceding vehicle in the front-rear direction is smaller than a first threshold value, a reaction force is applied to the accelerator pedal by the reaction force application mechanism. This enables the driver to be alerted to the fact that they are approaching the preceding vehicle. In a case in which the vehicle spacing in the vehicle width direction between the host vehicle and the preceding vehicle is larger than the second threshold in the applied state, the reaction force applied to the accelerator pedal is reduced by the reaction force application mechanism, enabling avoidance of any hindrance to driving in a case in which the driver wishes to accelerate. “Controls the reaction force application mechanism so as to reduce the reaction force applied to the accelerator pedal” as used herein is a concept including a configuration in which a state in which the reaction force that has been applied by the reaction force application mechanism is released.

A vehicle control device of a third aspect is the second aspect, in which the processor controls the reaction force application mechanism so as to reduce the reaction force applied to the accelerator pedal in a case in which the vehicle spacing in the vehicle width direction between the host vehicle and the preceding vehicle is larger than a second threshold value in the applied state and a relative movement distance of the preceding vehicle in the vehicle width direction relative to the host vehicle has increased.

In the vehicle control device of the third aspect, by reducing the reaction force applied to the accelerator pedal in consideration not only of the vehicle spacing between the host vehicle and the preceding vehicle in the vehicle width direction but in consideration also of the relative movement distance of the preceding vehicle with respect to the host vehicle in the vehicle width direction, safety can be enhanced while maintaining comfort.

A vehicle control device of a fourth aspect is any one of the first aspect to the third aspect, in which the processor acquires travel lane position information and calculates the vehicle spacing in the vehicle width direction between the host vehicle and the preceding vehicle based on the position information regarding the preceding vehicle and the travel lane position information.

In the vehicle control device of the fourth aspect, since the reaction force applied to the accelerator pedal can be reduced in cases in which the preceding vehicle has moved across a lane boundary to an adjacent lane, it is possible to accurately determine whether or not the host vehicle is able to accelerate.

A vehicle of a fifth aspect includes: a sensor configured to detect a preceding vehicle; a reaction force application mechanism configured to apply a reaction force to an accelerator pedal; and the vehicle control device recited in claim 1.

In the vehicle of the fifth aspect, the preceding vehicle is detected by the sensor, and a reaction force is applied to the accelerator pedal by the reaction force application mechanism. Further, the vehicle control device acquires position information regarding the preceding vehicle based on the information detected by the sensor, and based on the acquired position information for the preceding vehicle, the reaction force application mechanism is controlled based on the vehicle spacing between the host vehicle and the preceding vehicle in the front-rear direction and the vehicle width direction. This enables suppression of inadvertent application of a reaction force to the accelerator pedal in a situation in which the driver wishes to accelerate, such as immediately after the preceding vehicle has turned right or left.

A vehicle control method of a sixth aspect includes: acquiring position information regarding a preceding vehicle traveling ahead of a host vehicle; and controlling a reaction force application mechanism based on a vehicle spacing in a vehicle width direction between the host vehicle and the preceding vehicle, the reaction force application mechanism being configured to apply a reaction force to an accelerator pedal.

A non-transitory storage medium of a seventh aspect is a non-transitory storage medium storing a program executable by a computer to perform processing, the processing including: acquiring position information regarding a preceding vehicle traveling ahead of a host vehicle; and controlling a reaction force application mechanism based on a vehicle spacing in a vehicle width direction between the host vehicle and the preceding vehicle, the reaction force application mechanism being configured to apply a reaction force to an accelerator pedal.

The vehicle control device, the vehicle control method, and the non-transitory storage medium storing the program according to the present disclosure enable driving assistance to be performed without hindering driving.

### BRIEF DESCRIPTION OF THE DRAWINGS

Exemplary embodiments of the present disclosure will be described in detail based on the following figures, wherein:

FIG. 1 is a block diagram illustrating a hardware configuration of a vehicle according to an exemplary embodiment;

FIG. 2 is a block diagram illustrating a functional configuration of a vehicle control device according to an exemplary embodiment;

FIG. 3 is a schematic diagram illustrating a state in which a host vehicle and a preceding vehicle in an exemplary embodiment are traveling in the same lane;

FIG. 4 is a schematic diagram illustrating a state in which the preceding vehicle has turned left from the state of FIG. 3;

FIG. 5 is a flowchart illustrating an example of a flow of vehicle control processing according to an exemplary embodiment; and

FIG. 6 is a schematic diagram illustrating a state in which a host vehicle and a preceding vehicle in a modified example travel along a curve in the same lane.

### DETAILED DESCRIPTION

Explanation follows regarding a vehicle 10 including a vehicle control device 12 according to an exemplary embodiment, with reference to the drawings.

Hardware Configuration of Vehicle 10

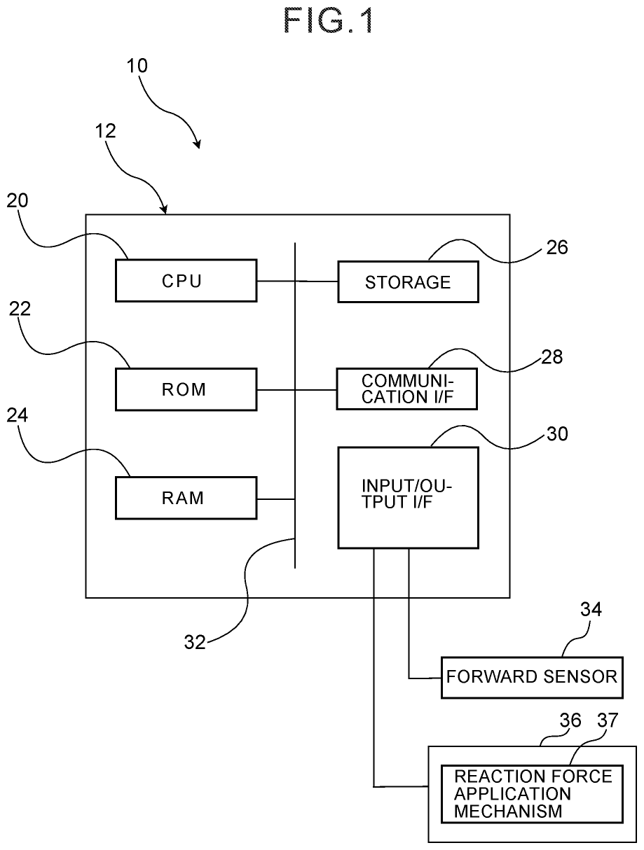

FIG. 1 is a block diagram illustrating a hardware configuration of a vehicle 10. As illustrated in FIG. 1, the vehicle 10 includes a vehicle control device 12. The vehicle control device 12 includes a central processing unit (CPU; a processor) 20, read only memory (ROM) 22, random access memory (RAM) 24, a storage 26, a communication interface (I/F) 28, and an input/output interface (I/F) 30. These respective configurations are connected together via a bus 32 so as to be capable of communicating with each other.

The CPU 20 is a central processing unit that executes various programs and controls various units. Namely, the CPU 20 reads a program from the ROM 22 or the storage 26, and executes the program using the RAM 24 as a workspace. Further, the CPU 20 controls the respective configurations and performs various computation processing in accordance with a program recorded in the ROM 22 or the storage 26.

The ROM 22 stores various programs and various data. The RAM 24 is a non-transitory recording medium that serves as a workspace to temporarily store programs and data. The storage 26 is configured by a hard disk drive (HDD) or a solid state drive (SSD), and is a non-transitory storage medium that stores various programs including an operating system, as well as various data. In the present exemplary embodiment, a vehicle control program, various data, and the like for performing vehicle control processing are stored in the storage 26.

The communication I/F 28 is an interface for the vehicle control device 12 to communicate with a server and other equipment and, for example, employs a protocol such as CAN (Controller Area Network), Ethernet (registered trademark), LTE (Long Term Evolution), FDDI (Fiber Distributed Data Interface), or Wi-Fi (registered trademark).

A forward sensor 34 and an accelerator pedal 36 are electrically connected to the input/output I/F 30. The forward sensor 34 is a sensor that is capable of detecting an obstacle ahead of the vehicle, and includes, for example, a camera, a radar, or LIDAR (Light Detection and Ranging or Laser Imaging Detection and Ranging). In particular, in the present embodiment, the forward sensor 34 is used to detect a preceding vehicle traveling ahead of the host vehicle.

The accelerator pedal 36 is disposed below the driving seat, and generates a propulsive force for the vehicle 10 in accordance with the amount of depression by which a driver depresses the accelerator pedal 36. The accelerator pedal 36 is provided with a reaction force application mechanism 37. The reaction force application mechanism 37 is a mechanism that is capable of applying a reaction force to the accelerator pedal 36, and includes, for example, a servo motor connected to the accelerator pedal 36. Further, by operating the reaction force application mechanism 37, a predetermined torque is generated from the servo motor, whereby a given reaction force can be applied to the accelerator pedal 36.

Moreover, the amount of depression of the accelerator pedal 36 can be detected by a stroke sensor incorporated in the servo motor, and the reaction force applied may be varied in accordance with the amount of depression of the accelerator pedal 36.

Functional Configuration of Vehicle Control Device 12

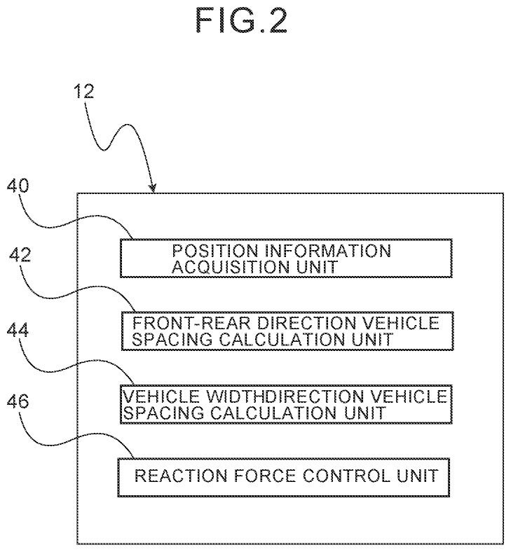

The vehicle control device 12 implements various functions using the hardware resources illustrated in FIG. 1. Explanation follows regarding the functional configuration implemented by the vehicle control device 12, with reference to FIG. 2.

As illustrated in FIG. 2, the vehicle control device 12 includes, as functional configuration, a position information acquisition unit 40, a front-rear direction vehicle spacing calculation unit 42, a vehicle width direction vehicle spacing calculation unit 44, and a reaction force control unit 46. The respective functional configurations are implemented by the CPU 20 reading and executing a program stored in the ROM 22 or the storage 26.

The position information acquisition unit 40 acquires position information regarding a preceding vehicle traveling ahead of the host vehicle. Specifically, the position information acquisition unit 40 acquires position information for the preceding vehicle based on information detected by the forward sensor 34.

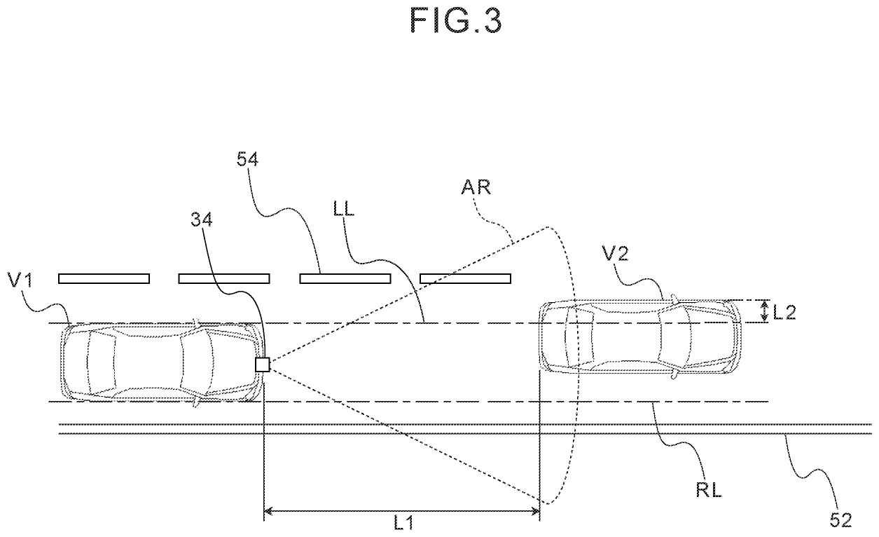

FIG. 3 illustrates a situation in which a preceding vehicle V2 is traveling in the same lane as the lane in which the host vehicle V1 is traveling. As illustrated in FIG. 3, in a case in which the preceding vehicle V2 is traveling as an obstacle in the detection range AR of the forward sensor 34 provided at the front of the host vehicle V1, the position information acquisition unit 40 acquires position information for the preceding vehicle V2. In FIGS. 3, 4, and 6, the size of the forward sensor 34 is exaggerated for convenience of explanation. Reference numeral 52 in the drawings denotes a center line, and reference numeral 54 in the drawings denotes a lane boundary line.

The front-rear direction vehicle spacing calculation unit 42 illustrated in FIG. 2 calculates a vehicle spacing in a front-rear direction between the host vehicle V1 and the preceding vehicle V2. Specifically, the front-rear direction vehicle spacing calculation unit 42, based on information acquired from the forward sensor 34 via the functionality of the position information acquisition unit 40, calculates the vehicle spacing between the host vehicle V1 and the preceding vehicle V2 in the front-rear direction. As an example, in FIG. 3, the distance L1 from the front end of the host vehicle V1 to the rear end of the preceding vehicle V2 is calculated as the vehicle spacing in the front-rear direction.

The vehicle width direction vehicle spacing calculation unit 44 calculates a vehicle spacing in the vehicle width direction between the host vehicle V1 and the preceding vehicle V2. Specifically, the vehicle width direction vehicle spacing calculation unit 44, based on information acquired from the forward sensor 34 via the functionality of the position information acquisition unit 40, calculates the vehicle spacing between the host vehicle V1 and the preceding vehicle V2 in the vehicle width direction. As an example, in FIG. 3, the distance L2 in the vehicle width direction of the preceding vehicle V2, which is outside a region between a right reference line RL and a left reference line LL of the host vehicle is calculated as the vehicle spacing in the vehicle width direction.

The reaction force control unit 46 controls the reaction force application mechanism 37 that applies a reaction force to the accelerator pedal 36 based on the vehicle spacing L1 in the front-rear direction and the vehicle spacing L2 in the vehicle width direction between the host vehicle V1 and the preceding vehicle V2. Specifically, in a case in which the vehicle spacing L1 between the host vehicle V1 and the preceding vehicle V2 in the front-rear direction, calculated by the functionality of the front-rear direction vehicle spacing calculation unit 42, is equal to or greater than a predetermined first threshold value, the reaction force control unit 46 does not apply a reaction force to the accelerator pedal 36.

Moreover, in a case in which the front-rear direction vehicle spacing L1 between the host vehicle V1 and the preceding vehicle V2, calculated by the functionality of the front-rear vehicle spacing calculation unit 42, has become smaller than the predetermined first threshold value, the reaction force control unit 46, in principle, applies a reaction force to the accelerator pedal 36. As an example, in the present exemplary embodiment, the reaction force control unit 46, in a case in which the preceding vehicle V2 is within the detection range AR of the forward sensor 34, applies a reaction force to the accelerator pedal 36. Moreover, the reaction force control unit 46 controls the reaction force application mechanism 37 so as to increase the reaction force applied to the accelerator pedal 36 as the vehicle spacing L1 between the host vehicle V1 and the preceding vehicle V2 in the front-rear direction becomes smaller.

Moreover, the reaction force control unit 46, in a case in which the vehicle spacing L2 between the host vehicle V1 and the preceding vehicle V2 in the vehicle width direction is larger than a second threshold value in an applied state in which a reaction force is applied to the accelerator pedal 36, controls the reaction force application mechanism 37 so as to reduce the reaction force applied to the accelerator pedal 36. The second threshold value is set to a distance at which the host vehicle V1 will not collide with the preceding vehicle V2 even in a case in which the host vehicle V1 has started accelerating.

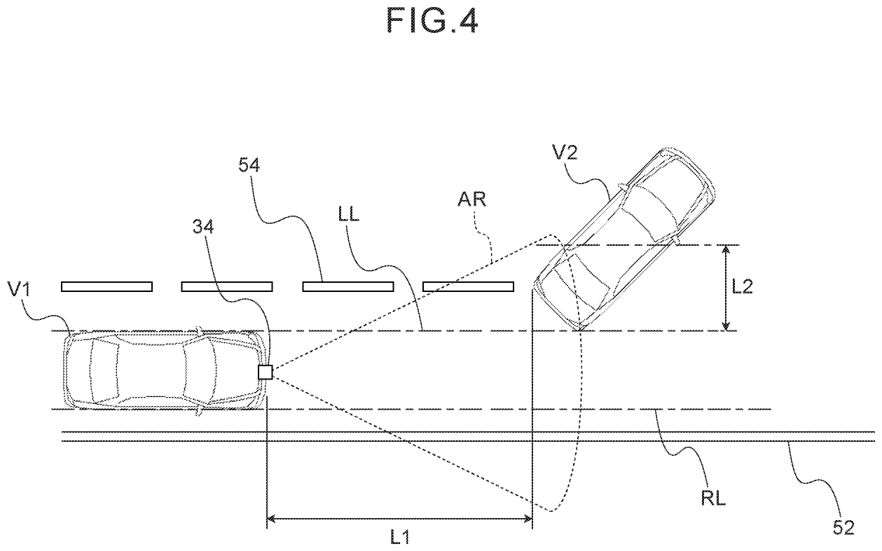

FIG. 4 illustrates a situation in which the preceding vehicle V2 has started to turn left. As illustrated in FIG. 4, the vehicle spacing L1 between the host vehicle V1 and the preceding vehicle V2 in the front-rear direction is the same distance as in FIG. 3. Further, the vehicle spacing L2 between the host vehicle V1 and the preceding vehicle V2 in the front-rear direction within the detection range AR of the forward sensor 34 is a larger distance than in FIG. 3, and is larger than the second threshold value. In this case, the reaction force control unit 46 controls the reaction force application mechanism 37 so as to reduce the reaction force applied to the accelerator pedal 36.

The reaction force control unit 46, in a case in which the vehicle spacing L2 between the host vehicle V1 and the preceding vehicle V2 in the vehicle width direction is larger than the second threshold value in the applied state in which a reaction force is applied to the accelerator pedal 36, and in a case in which the relative movement distance of the preceding vehicle V2 relative to the host vehicle V1 in the vehicle width direction has increased, may control the reaction force application mechanism 37 so as to reduce the reaction force applied to the accelerator pedal 36. In this case, as compared to a case in which the reaction force applied to the accelerator pedal 36 is controlled solely with reference to the vehicle width direction between the host vehicle V1 and the preceding vehicle V2, safety performance can be further improved.

Various methods may be employed when controlling the reaction force application mechanism 37 so as to reduce the reaction force applied to the accelerator pedal 36. For example, in a case in which the vehicle spacing L2 between the host vehicle V1 and the preceding vehicle V2 in the vehicle width direction has become larger than the second threshold value, the reaction force control unit 46 may release the state of application of reaction force by the reaction force application mechanism 37. Moreover, the reaction force control unit 46 may gradually reduce the reaction force applied to the accelerator pedal 36 in a case in which the vehicle spacing L2 between the host vehicle V1 and the preceding vehicle V2 in the vehicle width direction has become larger than the second threshold value. Moreover, the reaction force control unit 46, in a case in which the vehicle spacing L2 between the host vehicle V1 and the preceding vehicle V2 in the vehicle width direction has become larger than the second threshold, may control the reaction force application mechanism 37 so as to reduce the reaction force in conjunction with the increase in the vehicle spacing in the vehicle width direction.

Mechanism

Next, explanation follows regarding the mechanism of the present exemplary embodiment.

Vehicle Control Processing

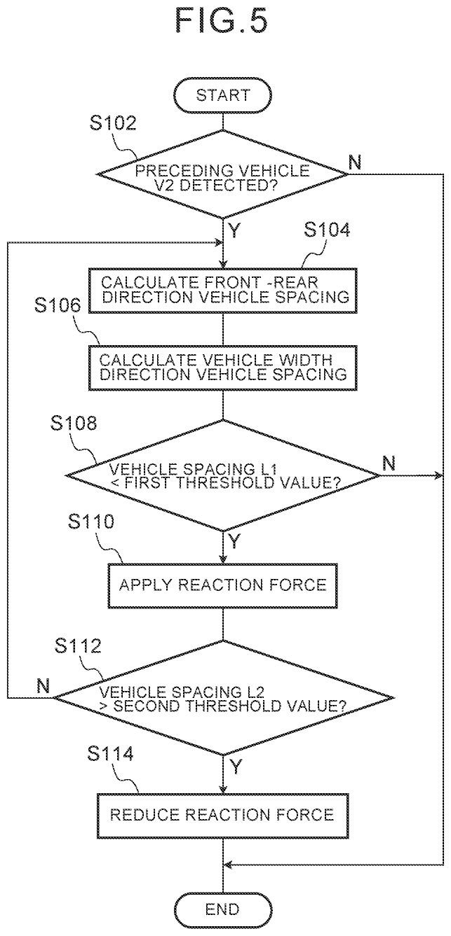

FIG. 5 is a flowchart illustrating an example of a flow of vehicle control processing performed by the vehicle control device 12 according to the present exemplary embodiment. This vehicle control processing is executed by the CPU 20 reading a program from the storage 26 and expanding this program in the RAM 24.

As illustrated in FIG. 5, the CPU 20 determines whether or not the preceding vehicle V2 has been detected at step S102. Specifically, in a case in which a preceding vehicle V2 has been detected by the forward sensor 34, the CPU 20 makes an affirmative determination at step S102, and transitions to the processing at step S104. Further, in a case in which the forward sensor 34 has not detected a preceding vehicle V2, the vehicle control processing is ended.

At step S104, the CPU 20 calculates the front-rear direction vehicle spacing L1 between the host vehicle V1 and the preceding vehicle V2. Moreover, at step S106, the CPU 20 calculates the vehicle spacing L2 in the vehicle width direction between the host vehicle V1 and the preceding vehicle V2.

At step S108, the CPU 20 determines whether or not the vehicle spacing in the front-rear direction is smaller than a first threshold value. In a case in which the vehicle spacing L1 between the host vehicle V1 and the preceding vehicle V2 in the front-rear direction is smaller than the first threshold value, the CPU 20 transitions to the processing of step S110. Moreover, in a case in which the vehicle spacing L1 in the front-rear direction is equal to or larger than the first threshold value, the CPU 20 ends the vehicle control processing without applying a reaction force to the accelerator pedal 36.

At step S110, the CPU 20 applies a reaction force to the accelerator pedal 36. Specifically, the CPU 20 applies a predetermined reaction force to the accelerator pedal 36 by actuating the reaction force application mechanism 37 utilizing the functionality of the reaction force control unit 46.

At step S112, the CPU 20 determines whether or not the vehicle spacing L2 in the vehicle width direction is larger than a second threshold value. In a case in which the vehicle spacing L2 between the host vehicle V1 and the preceding vehicle V2 in the vehicle width direction is larger than the second threshold value, the CPU 20 transitions to the processing of step S114. In a case in which the vehicle spacing L2 between the host vehicle V1 and the preceding vehicle V2 in the vehicle width direction is equal to or smaller than the second threshold value, the CPU 20 returns to the processing of step S104, and performs calculation of vehicle spacing.

The CPU 20 reduces the reaction force applied to the accelerator pedal 36 at step S114. Specifically, the CPU 20 controls the reaction force application mechanism 37 utilizing the functionality of the reaction force control unit 46 so as to reduce the reaction force applied to the accelerator pedal 36.

As described above, in the vehicle control device 12 according to the present exemplary embodiment, in addition to the reaction force application mechanism 37 being controlled based on the front-rear direction vehicle spacing L1 between the host vehicle V1 and the preceding vehicle V2, the reaction force application mechanism 37 is also controlled in consideration of the vehicle spacing L2 between the host vehicle V1 and the preceding vehicle V2 in the vehicle width direction. Namely, the reaction force application mechanism 37 is controlled based on the risk of the host vehicle V1 contacting the preceding vehicle V2. This enables inadvertent application of reaction force to the accelerator pedal 36 in a situation in which the driver wishes to accelerate, such as immediately after the preceding vehicle V2 has turned right or left, to be suppressed.

Moreover, in the present exemplary embodiment, in a case in which the vehicle spacing L1 between the host vehicle V1 and the preceding vehicle V2 in the front-rear direction is smaller than the first threshold value, a reaction force is applied to the accelerator pedal 36 by the reaction force application mechanism 37. This enables the driver to be alerted to the fact that they are approaching the preceding vehicle V2.

Further, in a case in which the vehicle spacing L2 between the host vehicle V1 and the preceding vehicle V2 in the vehicle width direction is larger than the second threshold value in the applied state in which a reaction force has been applied, the reaction force applied to the accelerator pedal 36 by the reaction force application mechanism 37 is reduced, enabling the avoidance of any hindrance to driving in a case in which the driver wishes to accelerate.

In the exemplary embodiments described above, as illustrated in FIG. 3, the distance L1 from the forward end of the host vehicle V1 to the rearward end of the preceding vehicle V2 is calculated as the vehicle spacing in the front-rear direction, and the distance L2 in the vehicle width direction of the preceding vehicle V2 present outside of the region between the right reference line RL and the left reference line LL is calculated as the vehicle spacing in the vehicle width direction; however, there is no limitation thereto, and another method may be used to calculate the vehicle spacing.

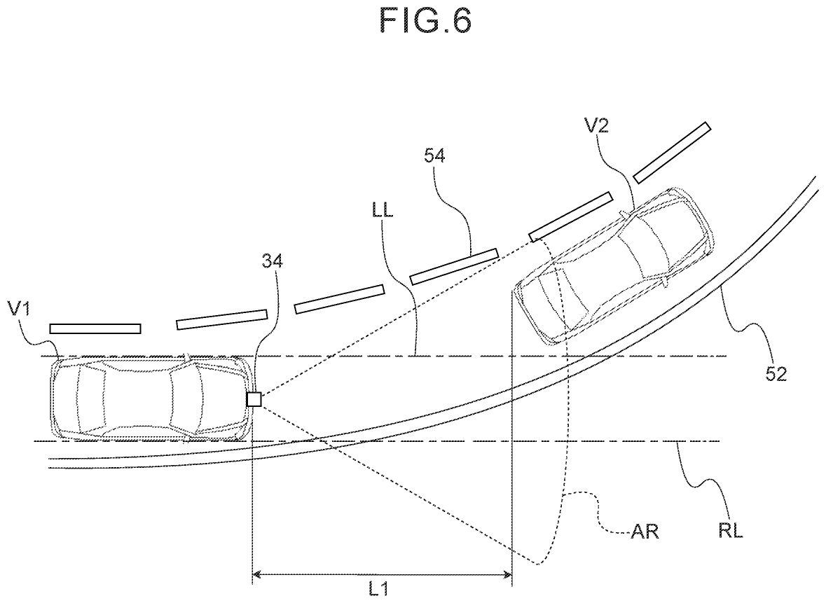

As an example, the forward sensor 34, another camera, or the like can acquire position information regarding a travel lane and, based on the position information for the preceding vehicle V2 and the position information for the lane, the vehicle spacing in a vehicle width direction between the host vehicle V1 and the preceding vehicle V2 may be calculated. Explanation follows regarding this method, with reference to FIG. 6.

### Modified Example

FIG. 6 is a schematic diagram illustrating a state in which the host vehicle V1 and the preceding vehicle V2 travel along a curve in the same lane. As illustrated in FIG. 6, the front-rear direction vehicle spacing calculation unit 42 calculates the distance L1 from the front end of the host vehicle V1 to the rear end of the preceding vehicle V2 as the vehicle spacing in the front-rear direction. Further, the vehicle width direction vehicle spacing calculation unit 44 calculates the distance by which the preceding vehicle V2 has crossed the lane boundary line 54 as the vehicle spacing in the vehicle width direction.

According to the present modified example, even in a case in which the preceding vehicle V2 deviates from the region between the right reference line RL and the left reference line LL in a state in which the vehicle is traveling along a curve on the same lane, by calculating the distance by which the preceding vehicle V2 has crossed the lane boundary line 54 as the distance in the vehicle width direction, the vehicle spacing in the vehicle width direction is determined to be equal to or less than the second threshold value, which enables suppression of any reduction in the reaction force applied to the accelerator pedal 36. Further, since the reaction force applied to the accelerator pedal 36 decreases in a case in which the preceding vehicle V2 moves to an adjacent lane across the lane boundary line 54, it is possible to accurately determine whether or not the host vehicle V1 is able to accelerate.

Although explanation has been given in the foregoing regarding the vehicle control device 12 according to the exemplary embodiment and the modified example, it will be clear that various embodiments may be implemented within a range not departing from the gist of the present disclosure. For example, while the reaction force application mechanism 37 of the present exemplary embodiment is configured to apply a given reaction force to the accelerator pedal 36 by generating a predetermined torque from a servo motor, other mechanisms may apply a reaction force to the accelerator pedal 36. For example, a reaction force may be applied to the accelerator pedal 36 by a mechanism employing a cylinder, hydraulic pressure, or the like.

Further, in the above-described exemplary embodiment, in a case in which the vehicle spacing between the host vehicle V1 and the preceding vehicle V2 in the front-rear direction is smaller than the first threshold value, a reaction force is applied to the accelerator pedal 36, and the reaction force application mechanism 37 is controlled so as to reduce the reaction force applied to the accelerator pedal 36 in a case in which the vehicle width direction between the host vehicle V1 and the preceding vehicle V2 is larger than the second threshold value; however, there is no limitation thereto. For example, a configuration may be adopted in which a reaction force is applied to the accelerator pedal 36 only in a case in which the vehicle spacing between the host vehicle V1 and the preceding vehicle V2 in the front-rear direction is smaller than the first threshold value and the vehicle spacing between the host vehicle V1 and the preceding vehicle V2 in the vehicle width direction is equal to or less than the second threshold value.

Moreover, in the exemplary embodiment described above, as illustrated in FIG. 3, the distance L2 in the vehicle width direction of the preceding vehicle V2, which is outside the region between the right reference line RL and the left reference line LL of the host vehicle V1, is calculated as the vehicle spacing in the vehicle width direction; however, there is no limitation thereto, and other methods may be used to calculate the vehicle spacing in the vehicle width direction. For example, in a case in which the preceding vehicle V2 is present in a region between the right reference line RL and the left reference line LL, the vehicle spacing in the vehicle width direction may be calculated as 0, and the vehicle spacing in the vehicle width direction may be measured from a state in which the entire preceding vehicle V2 has moved outside this region. In this case, in a case in which the preceding vehicle V2 has moved 1 m to the left of the left reference line LL, the vehicle spacing in the vehicle width direction is calculated to be 1 m.

Moreover, the processing executed by the CPU 20 reading and executing a program in the above-described exemplary embodiment may be executed by various types of processor other than the CPU 20. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The respective processing may be executed by any one of these various types of processor, or by a combination of two or more of the same type or different types of processor, and may be executed by plural FPGAs, or by a combination of a CPU and an FPGA, for example. The hardware structure of these various types of processors is, more specifically, an electric circuit combining circuit elements such as semiconductor elements.

Although explanation has been given regarding an aspect in which the respective programs are stored (installed) in advance on a non-transitory recording medium that is readable by a computer, there is no limitation thereto, and the respective programs may be provided in a format recorded on a non-transitory recording medium such as compact disc read only memory (CD-ROM), digital versatile disc read only memory (DVD-ROM), or universal serial bus (USB) memory. Alternatively, the programs may be provided in a format downloadable from an external device over a network.

Moreover, the flow of processing described in the foregoing exemplary embodiment is an example, and unnecessary steps may be deleted, new steps may be added, or the processing order may be rearranged within a range not departing from the spirit of the present disclosure.

What is claimed is:

1. A vehicle control device, comprising a processor, the processor being configured to:
acquire position information regarding a preceding vehicle traveling ahead of a host vehicle; and
control a reaction force application mechanism based on a vehicle spacing in a vehicle width direction between the host vehicle and the preceding vehicle, the reaction force application mechanism being configured to apply a reaction force to an accelerator pedal.

2. The vehicle control device recited in claim 1, wherein a state in which the reaction force has been applied to the accelerator pedal in a case in which a vehicle spacing in a front-rear direction between the host vehicle and the preceding vehicle is smaller than a first threshold value is designated an applied state, and the processor controls the reaction force application mechanism so as to reduce the reaction force applied to the accelerator pedal in a case in which the vehicle spacing in the vehicle width direction between the host vehicle and the preceding vehicle is larger than a second threshold value in the applied state.

3. The vehicle control device recited in claim 2, wherein the processor controls the reaction force application mechanism so as to reduce the reaction force applied to the accelerator pedal in a case in which the vehicle spacing in the vehicle width direction between the host vehicle and the preceding vehicle is larger than a second threshold value in the applied state and a relative movement distance of the preceding vehicle in the vehicle width direction relative to the host vehicle has increased.

4. The vehicle control device recited in claim 1, wherein the processor acquires travel lane position information and calculates the vehicle spacing in the vehicle width direction between the host vehicle and the preceding vehicle based on the position information regarding the preceding vehicle and the travel lane position information.

5. A vehicle, comprising:
a sensor configured to detect a preceding vehicle;
a reaction force application mechanism configured to apply a reaction force to an accelerator pedal; and
the vehicle control device recited in claim 1.

6. A method of controlling a vehicle, the method comprising:
acquiring position information regarding a preceding vehicle traveling ahead of a host vehicle; and
controlling a reaction force application mechanism based on a vehicle spacing in a vehicle width direction between the host vehicle and the preceding vehicle, the reaction force application mechanism being configured to apply a reaction force to an accelerator pedal.

7. A non-transitory storage medium storing a program executable by a computer to perform processing, the processing comprising:
acquiring position information regarding a preceding vehicle traveling ahead of a host vehicle; and
controlling a reaction force application mechanism based on a vehicle spacing in a vehicle width direction between the host vehicle and the preceding vehicle, the reaction force application mechanism being configured to apply a reaction force to an accelerator pedal.
